(19) United States
(12) Patent Application Publication
(10) Pub. No.: US 2013/0241269 A1
(43) Pub. Date: Sep. 19, 2013

(54) RIM LINER

(71) Applicants: Peter Gilbert, Collingwood (CA); Radu Repanovici, Mississauga (CA)

(72) Inventors: Peter Gilbert, Collingwood (CA); Radu Repanovici, Mississauga (CA)

(21) Appl. No.: 13/619,494

(22) Filed: Sep. 14, 2012

Related U.S. Application Data
(60) Provisional application No. 61/535,132, filed on Sep. 15, 2011.

(51) Int. Cl. B60B 21/12

(52) U.S. Cl. CPC B60B 21/12
USPC 301/95.102

(57) ABSTRACT

A rim assembly for receiving a tire includes a rim having an outer ring-shaped member defining an outer surface, and a rim liner having a ring-shaped body formed to generally match the contours of the outer surface of the rim. The rim liner is positioned within a recess formed in at least a portion of the outer surface of the rim so as to maintain an intended industry standard sizing for rims and tires.

### CROSS-REFERENCE TO RELATED APPLICATIONS

This application is a non-provisional application claiming the benefit under 35 U.S.C. §119(e) of U.S. Provisional Patent Application No. 61/535,132 filed Sep. 15, 2011, which is hereby incorporated by reference in its entirety herein.

### FIELD OF THE INVENTION

The present invention relates to ensuring a seal between a tire and a rim, and in particular to a rim liner to be used with the tire and rim to reduce air leakage in the region of the bead-set and main body region of the rim.

### BACKGROUND OF THE INVENTION

Automotive wheels are typically assemblies having a tire and a rim, where the assembly is pressurized with air to a set pressure rating, typically in the region of 30 to 40 psi. As a vehicle's tires are the primary and in most cases the only contact surface with the road, they are subject to harsh conditions.

Modern automotive rims, particularly alloy rims are subject to a range of potentially degradative compounds during usage, for example road salt. Prolonged exposure to these compounds can lead to chemical attack, generally in the form of corrosion and/or oxidation of the rims. Where chemical attack occurs at the tire bead/rim interface, air leakage can occur, resulting in a loss of tire pressure. Underinflation by as little as 6 psi can have serious consequences, such as reduced tread life, reduced fuel economy and in some instances tire failure.

Road conditions also have the potential to cause physical damage to the rims. Where this damage occurs at or in proximity to the tire bead/rim interface, the chances of air leakage are increased. Once again, with underinflation of the tires, serious consequences can arise.

There is clearly a need to address the tire bead/rim interface, particularly with respect to providing additional sealing function in the event of rim chemical attack and/or physical damage.

### SUMMARY OF THE INVENTION

According to an aspect of an embodiment, provided is a rim assembly for receiving a tire. The assembly comprises a rim having an outer ring-shaped member defining an outer surface, and a rim liner having a ring-shaped body formed to generally match the contours of the outer surface of the rim. The rim liner is positioned within a recess formed in at least a portion of the outer surface of the rim so as to maintain an intended industry standard sizing for rims and tires.

According to a further aspect of an embodiment, provided is a rim liner for placement between a tire and a rim of an automotive wheel assembly. The rim liner comprises a ring-shaped body formed to generally match the contours of an outer surface of the rim, the ring-shaped body being configured to seat within a recess provided in the rim, so as to maintain an intended industry standard sizing for rims and tires.

### BRIEF DESCRIPTION OF THE DRAWINGS

The foregoing and other features and advantages of the invention will be apparent from the following description of the invention as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIG. 1 is a perspective view of a wheel having a tire and rim.

FIG. 2 is a perspective view of a rim shown in isolation.

FIG. 3 is a partial sectional view of the rim represented in FIG. 2.

FIG. 4 is an exploded perspective view of the rim and a rim liner configured for installation on the rim, according to an embodiment of the invention.

FIG. 5 is a partial sectional view of the rim showing a recess configured to receive the rim liner of FIG. 4.

FIGS. 6 and 7 are partial sectional views showing the rim liner of FIG. 4 in position on the rim.

FIG. 8 is a partial section view of an alternate installation of the rim liner on the rim.

### DESCRIPTION OF PREFERRED EMBODIMENT

Specific embodiments of the present invention will now be described with reference to the figures. The following detailed description is merely exemplary in nature and is not intended to limit the invention or the application and uses of the invention. A person skilled in the relevant art will recognize that other configurations and arrangements can be used without departing from the scope of the invention. Although the description of the embodiments hereof is in the context of automotive rims, the invention may also be used in rim applications for other types of wheeled vehicles and equipment, including split rim and run flat applications. Furthermore, there is no intention to be bound by any expressed or implied theory presented in the preceding technical field, background, brief summary or the following detailed description.

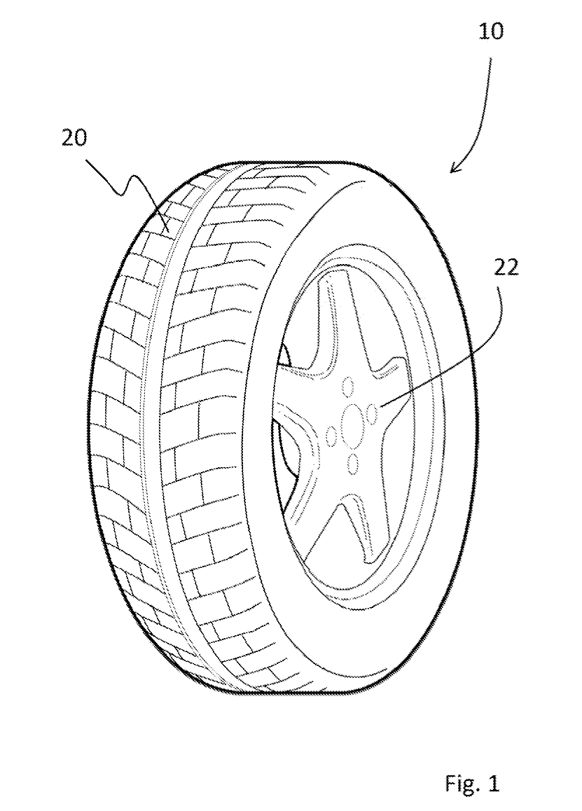

Presented in FIG. 1 is perspective view of a wheel 10, such as for an automobile, where the wheel generally includes a tire 20 and a rim 22. While exemplified with respect to a wheel of an automobile, the invention will work with the wheel of any type of vehicle including but not limited to cars, trucks, heavy trucks, buses, all-terrain vehicles, bicycles and aircraft.

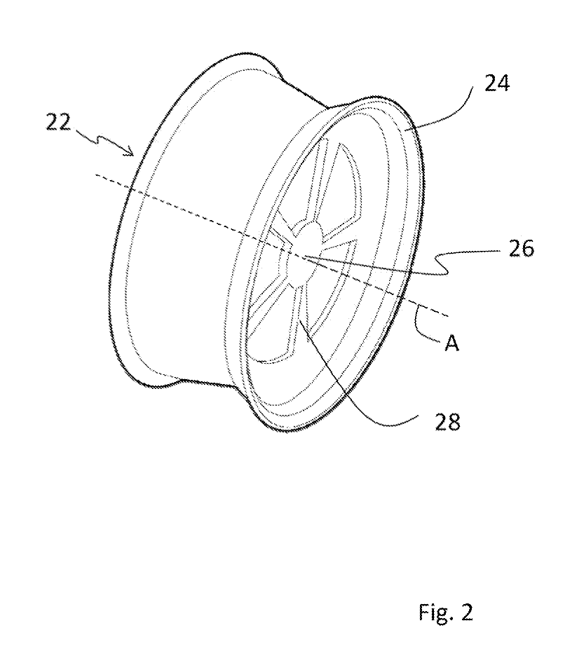

Turning now to FIG. 2, rim 22 is configured to support tire 20. Rim 22 is generally made of a metal such as an aluminum alloy, magnesium or steel. Rim 22 includes an outer ring-shaped member 24 connected to a central hub 26 through an intermediate connection member 28. As shown, outer ring-shaped member 24, central hub 26 and intermediate connection member 28 are unitary, that is rim 22 is of one-piece construction. As will be appreciated, other rim systems are possible where at least one of outer ring-shaped member 24, central hub 26 and intermediate connection member 28 are formed as a separate component, and incorporated into the overall rim assembly, for example as found with split rim or combinations of run-flat geometries. While intermediate connection member 28 is represented in a spoke-like configuration, that is with a series of 5 radially extending support vanes connecting hub 26 to outer ring-shaped member 24, intermediate connection member 28 may be provided in a range of styles as dictated by the design of rim 22, where functionally, intermediate connection member 28 serves to provide a secure connection between central hub 26 and outer ring-shaped member 24.

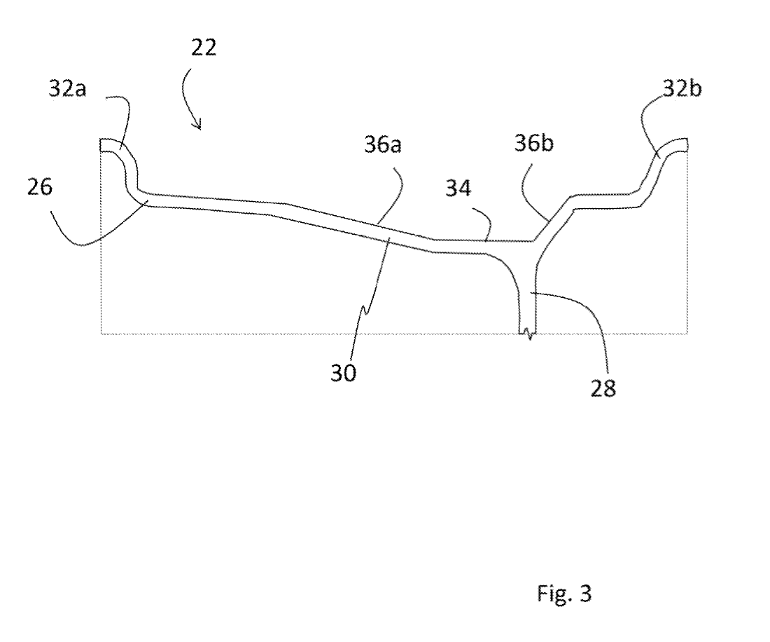

Referring now to FIG. 3, outer ring-shaped member 26 of rim 22 includes a base 30, and a pair of flange members 32a/b. Flange members 32a/b are generally disposed symmetrically with respect to base 30 extending from both ends of base 30 in the radially outward direction having regard to axis A of rim 22. Also formed into base 30 is a drop center 34 having angled surfaces 36a/b to facilitate the mounting of tire 20 during the installation process. Rim 22 is also configured to accommodate a valve stem (not shown) by providing a valve stem hole or similar feature (also not shown) to permit inflation of tire 20 mounted on rim 22.

Air leakage from the tire bead/rim interface can arise from a number of reasons. In particular, leakage can arise from physically damaged rims (e.g. dents, cracks, etc.) as well as from rims having corrosion or oxidation along the bead-set. Corrosion issues are of particular concern with alloy rims (e.g. aluminum alloy) where galvanic corrosion or chemical attack arising from environmental factors (e.g. asphalt, salt, etc) can be especially problematic around the tire bead seat and across the main body of the rim. Moisture introduced to the tire through the valve steam during inflation can also initiate oxidation on the main body of the rim causing slow propagation of air leak directly through the rim.

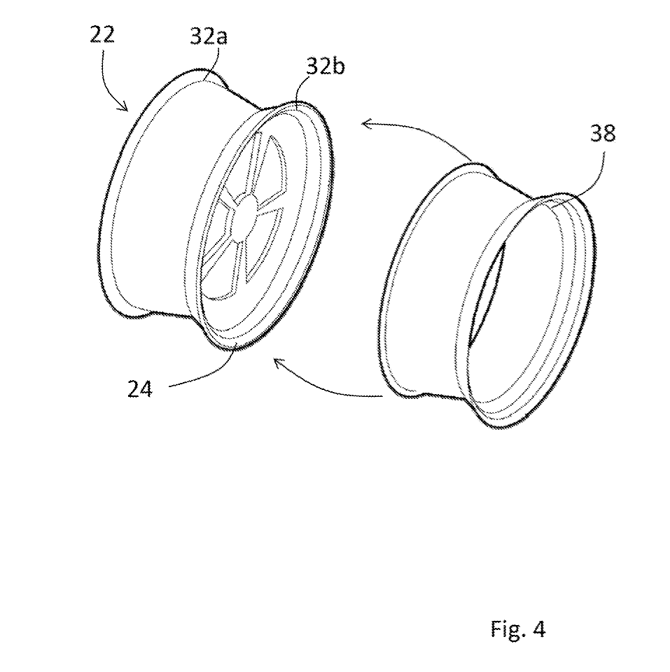

To reduce the possibility of air leakage from the tire bead/rim interface, and the main body of the rim in general, a supplemental rim liner, such as that shown in FIG. 4 may be utilized. Rim liner 38 is generally ring-shaped and designed to fit on outer ring-shaped member 24 of rim 22. As such, at the tire bead/rim interface, rim liner 38 provides an added barrier to reduce the potential impacts of oxidation and/or physical rim damage at the bead seal directly, or across the main body of the rim.

Rim liner 38 may be formed of any suitable elastomeric, polymeric or thermoplastic polyester elastomeric (TPE)-based material having the desired performance characteristics, for example low permeation. For installation purposes, it is useful for rim liner 38 to be made of a material capable of being stretched over one of flange members 32a/b, similar to standard tire installation procedure. Suitable materials include, but are not limited to thermoplastic polyester elastomers (e.g. Hytrel™) particularly those having low permeation characteristics, but as will be appreciated, other materials having the required performance characteristics may also be implemented.

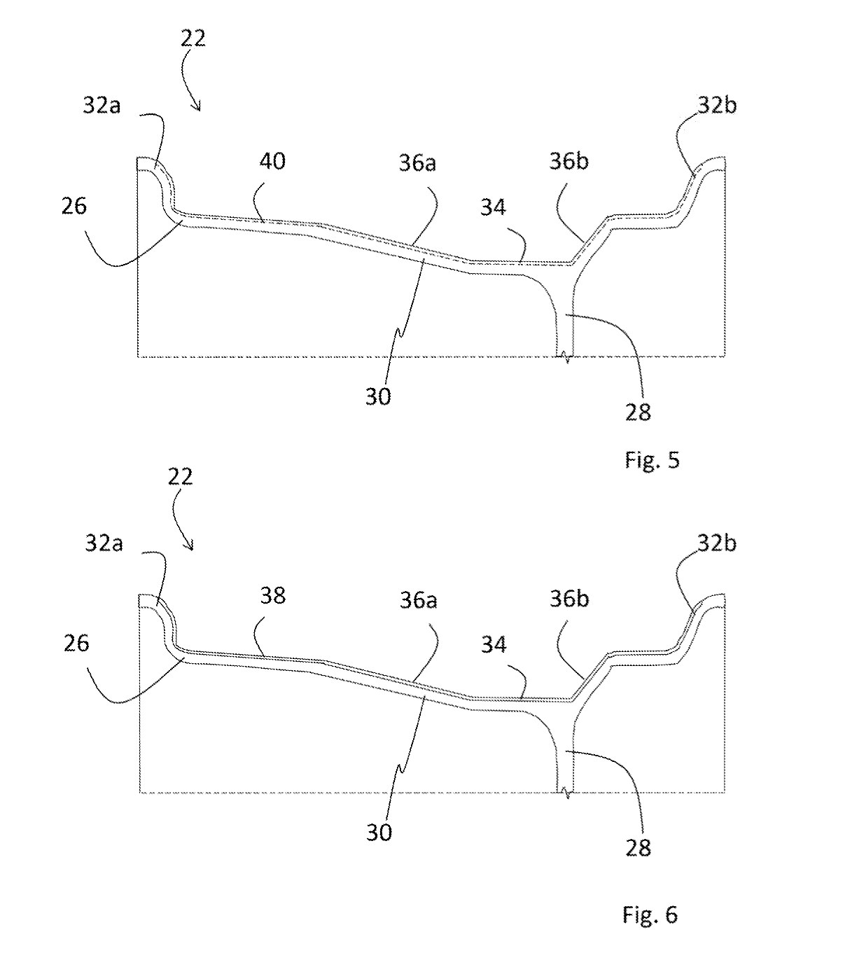

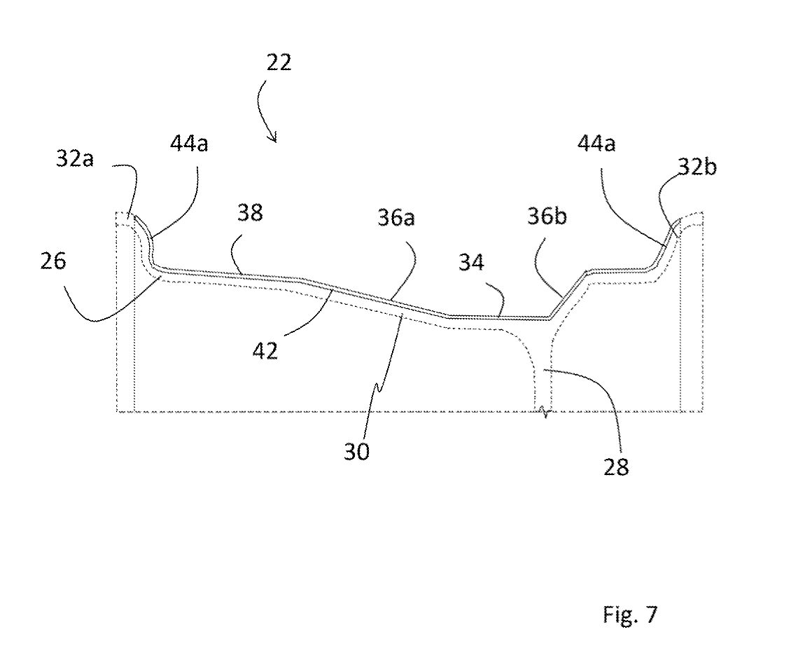

For motor vehicles, there are standards, for example the Federal Motor Vehicle Safety Standard which defines requirements for a variety of factors, such as tire dimensions, high speed performance, endurance, low inflation pressure performance, tire strength, and bead unseating resistance. Tire/rim sizing can have a major influence on these factors; consequently, tire/rim sizing is very specific in order to achieve a proper seal therebetween. Tolerances are such that minor variances in rim and/or tire diameter can impact whether or not a proper and sustainable seal is established. As such, and as shown in FIGS. 5 and 6, rim liner 38 is configured to seat within a recess 40 (shown in dot) provided on flange members 32a/b and base 30 of rim 22.

Accordingly, referring now to FIG. 7, rim liner 38 is generally a ring-shaped body formed to match the contours of the outer surface of outer ring-shaped member 26 of rim 22. As shown, rim liner 38 includes a liner base 42 having a profile to match/cooperate with rim base 30, including drop center 34. Rim liner 38 also provides a pair of flange extensions 44a/b that match/cooperate with flange members 32a/b of rim 22. As such, on installation of rim liner 38 on rim 22, the final diameter of the resulting rim assembly conforms to industry standard sizing for rims and tires.

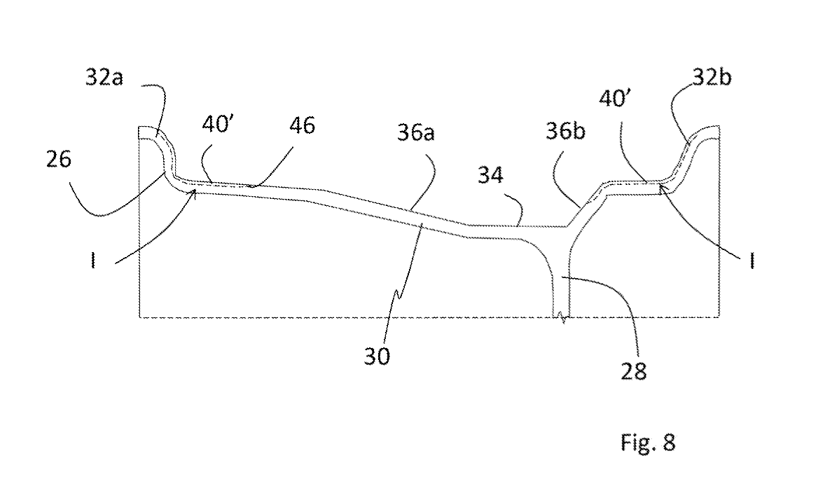

While recess 40 is detailed above and in the figures as being provided substantially across the entire outer surface of the outer ring-shaped member of rim 26, that is on both flange members 32a/b and base 30, in some embodiments, the recess to accommodate rim liner 38 is limited to the regions defining the original tire bead/rim interface I. For example, as shown in FIG. 8, rim 22 is configured to provide a pair recesses 40′ that receive rim liner 38 (not shown for clarity). The central region in-between is not recessed as conformation to a specified industry standard diameter is less critical along base 30. To reduce localized stresses in rim liner 38, the transition 46 between the machined and non-machined areas maybe sloped or tapered, or otherwise provided with a gradual transition.

Rim liner 38 is generally provided with a thickness in the range of 0.5 mm to 1.5 mm, although a thickness above or below this range may be used. As will be appreciated, recess 40 (40′), designed to accommodate rim liner 38 is similarly dimensioned so as to achieve the aforementioned industry standard sizing. As such, recess 40 (40′) will also generally be provided in the range of 0.5 to 1.5 mm deep. For example, in one particular embodiment, where rim liner 38 is provided with a thickness of 0.8 mm, recess 40 (40′) is similarly provided with a depth of 0.8 mm. It will be appreciated, however that in some embodiments, rim liner 38 may be provided with a thickness that is either less than, or greater than the depth defining recess 40 (40′).

Recess 40 (40′) provided on rim 22 may be formed through a post-manufacturing machining process. For example, in the case of used rims having corrosion at the tire bead/rim interface, the corrosion may be machined off to provide recess 40 (40′) having the required dimensions to seat rim liner 38 in position. A post-manufacturing machining process may also be used on newly manufactured rims so as to achieve recess 40 (40′). In general, the post-manufacturing machining process is contemplated as an aftermarket service available for upgrade and/or repair situations.

In new installations, for example with an original equipment manufacturer, while a post-manufacturing machining process may be used, it may be advantageous and cost effective to incorporate recess 40 (40′) into the initial rim design. As such, newly manufactured rims are provided with recess 40 (40′), subsequent to which they are fitted with rim liner 38 to achieve the final end product having the desire industry standard sizing.

While various embodiments according to the present invention have been described above, it should be understood that they have been presented by way of illustration and example only, and not limitation. It will be apparent to persons skilled in the relevant art that various changes in form and detail can be made therein without departing from the scope of the invention. Thus, the breadth and scope of the present invention should not be limited by any of the above-described exemplary embodiments, but should be defined only in accordance with the appended claims and their equivalents. It will also be understood that each feature of each embodiment discussed herein, and of each reference cited herein, can be used in combination with the features of any other combination. All patents and publications discussed herein are incorporated by reference herein in their entirety.

1. A rim assembly for receiving a tire, comprising:
a rim having an outer ring-shaped member defining an outer surface; and
a rim liner having a ring-shaped body formed to generally match the countours of said outer surface of said rim,
wherein said rim liner is positioned within a recess formed in at least a portion of said outer surface of said rim so as to maintain an intended industry standard sizing for rims and tires.

2. The rim assembly according to claim 1, wherein said rim liner is manufactured of a low permeation material.

3. The rim assembly according to claim 2, wherein said low permeation material is a thermoplastic polyester elastomeric-based material.

4. The rim assembly according to claim 3, wherein said thermoplastic polyester elastomeric-based material is Hytrel™.

5. The rim assembly according to claim 1, wherein said recess is provided substantially across said outer ring-shaped member.

6. The rim assembly according to claim 1, wherein said recess is limited to the regions defining the tire bead/rim interface.

7. The rim assembly according to claim 1, wherein said recess is provided with a depth that matches the thickness of the rim liner being used.

8. The rim assembly according to claim 1, wherein said rim liner is provided with a thickness in the range of 0.5 mm to 1.5 mm, and wherein said recess is dimensioned with a depth in the range of 0.5 mm to 1.5 mm.

9. A rim liner for placement between a tire and a rim of an automotive wheel assembly, the rim liner comprising:
a ring-shaped body formed to generally match the contours of an outer surface of said rim, said ring-shaped body being configured to seat within a recess provided in said rim, so as to maintain an intended industry standard sizing for rims and tires.

10. The rim liner according to claim 9, wherein said rim liner is manufactured of a low permeation material.

11. The rim liner according to claim 10, wherein said low permeation material is a thermoplastic polyester elastomeric-based material.

12. The rim liner according to claim 11, wherein said thermoplastic polyester elastomeric-based material is Hytrel™.

13. The rim liner according to claim 9, wherein said rim liner is provided with a thickness in the range of 0.5 mm to 1.5 mm.
